(19) United States
(12) Patent Application Publication
(10) Pub. No.: US 2012/0143518 A1
(43) Pub. Date: Jun. 7, 2012

(54) AUTOMATIC EVALUATION SYSTEM FOR VEHICLE DEVICES USING VEHICLE SIMULATOR

(75) Inventors: Jong Ho Kim, Hwaseong (KR); Jung Jun Lee, Seoul (KR)

(73) Assignee: HYUNDAI MOTOR COMPANY, Seoul (KR)

(21) Appl. No.: 13/164,064

(22) Filed: Jun. 20, 2011

(30) Foreign Application Priority Data
Dec. 2, 2010 (KR) 10-2010-0121994

(51) Int. Cl. G06F 19/00

(52) U.S. Cl. 702/33

(57) ABSTRACT

Disclosed is a system of automatically evaluating vehicle devices using a vehicle simulator. The system includes a vehicle simulator that is configured to replicate an actual vehicle in combination with vehicle devices mounted therein. The system also includes a system base configured to generate and output an input signal to be input into a controller in order to operate the vehicle devices that are targeted for evaluation according to contents set in a test case data entered by an evaluator. Additionally, the system base also measures and analyzes an output signal from the controller in response to the input signal. Further a signal connecting unit is configured to connect the vehicle simulator with the system base via a signal.

### CROSS-REFERENCE TO RELATED APPLICATION

This application claims under 35 U.S.C. §119(a) the benefit of Korean Patent Application No. 10-2010-0121994 filed Dec. 2, 2010, the entire contents of which are incorporated herein by reference.

### BACKGROUND

(a) Technical Field

The present invention relates to a system for evaluating vehicle devices. More particularly, it relates to an automatic evaluation system for vehicle devices that upgrades a to conventional manual evaluation mode to an automatic evaluation mode at a vehicle level thereby reducing the duration required for evaluation and development and securing the reliability of the evaluation accordingly.

(b) Background Art

With the extensive growth in number of vehicles and the remarkable development of the associated industries and electronic techniques, there has been an increasing need by vehicle drivers in terms of convenience, safety and assistance in vehicle operation.

To meet these needs, vehicle manufactures have recently been incorporating various convenience devices, safety equipments, auxiliary operation devices or the like into the vehicles they produce. For example, such devices may include a keyless entry system, a push button start system, an auto light system, a lamp system such as a door switch type room lamp and the like, a memory seat system, an automatic wiper system, a power window system, a rear side warning system, a voice warning system, clusters, multifunction switches, various kinds of vehicle devices and air conditioner associated with BCM (body control module), chassis control associated devices, etc.

Such devices are emerging as important tools to take the lead in the future vehicle market and various devices with new functions are currently being developed one after another to meet this need.

Incidentally, as a number of devices/tools in a vehicle increases compared with a to conventional vehicle, the number of evaluation items for a vehicle also rapidly increases, thereby taking a greater amount of time to input/output various kinds of signals for test and evaluation, measure experimental results, and evaluate and analyze the measured data.

One noted disadvantage of the current system for evaluating these new devices in a vehicle is that it is hard to determine whether a large number of vehicle devices such as electronic parts mounted in an actual vehicle, especially in a brand new vehicle models under development accurately operate in response to an input by a separate manipulation in order to check to see if each resultant output state is identical to a corresponding predetermined state. By “separate manipulation” it is meant that each and every manipulation of all vehicle devices (e.g., door switch, lamp, wiper, interior lamp, etc.) to be installed in an actual vehicle comprising inputting signals for each device, and examining whether the output state of each device exhibits a suitable response as predetermined.

Further, using the conventional method, each of the vehicle devices mounted in an actual vehicle should be inputted with signals in separate manual modes and the resultant output state from the vehicle devices should be evaluated repeatedly. However, such manual mode and repeatability may cause various problems such as overload in work, decrease in efficiency of work, a relatively long period of time for evaluation, incompletion of a reliable evaluation, etc.

Even in the case of simply inputting an on/off signal to the devices, the number of tests increases geometrically when considering the number of possible conditions in which the device could operate thereby making it impossible to practically check all of the related to conditions. Accordingly, an automated evaluation system for vehicle devices is needed.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention relates to an automatic evaluation system for one or more vehicle devices that enables an automatic evaluation to be utilized in an automotive evaluation process. Accordingly, the present invention allows an automotive manufacture to meet the rapidly changing environment in vehicle industry, especially in view of the growing number of advanced technology vehicles and the number of advanced devices mounted therein, thereby reducing the time required for evaluation while at the same time acquiring a reliable evaluation.

The present invention also relates to a method of enhancing evaluation efficiency of vehicles by converting various kinds of evaluation methods manually performed for various vehicle devices into automatic evaluation methods, and strengthening the preliminary diagnosis of functions of those methods. Thus, the present invention also secures product reliability by minimizing errors often caused by manual tests/manual evaluations, e.g., human errors.

In one aspect, the present invention provides a system for automatically evaluating to vehicle devices using a vehicle simulator. More specifically, the system includes a vehicle simulator that is configured to replicate an actual vehicle in combination with vehicle devices mounted in the vehicle. The system also includes a system base that generates and outputs an input signal which is sent to a controller to operate vehicle devices that are targeted for evaluation according to contents set in a test case data entered by an evaluator. The system base also measures and analyzes an output signal received from the controller in response to the input signal. Further, the system additionally includes a signal connecting unit that connects the vehicle simulator with the system base via a signal, e.g., a wireless signal.

According to the automatic evaluation system of the present invention, when evaluating vehicle devices such as various kinds of electronic parts and the like mounted in a vehicle, an automatic evaluation mode correlating with a particular vehicle level (i.e., the types of vehicle devices and wires that would be installed in the vehicle) may be employed using a vehicle simulator and test case data, thereby reducing the time for evaluation and development while securing the reliability of evaluation.

Particularly, the system according to the present invention serves provide a system in which methods previously manually performed to evaluate vehicle devices are converted to automatic evaluation methods, thereby enhancing the efficiency of evaluation, and minimizing errors caused by manual tests/manual checks, thus providing improved preliminary diagnosis of functions and secure the reliability in development quality in a much shorter time period.

In addition, the automatic evaluation system makes it possible for a vehicle to manufacturer to check the vehicle devices in cooperation with a parts manufacturer prior to each step of vehicle development thereby allowing an enhanced degree of completion in development quality.

Such automatic evaluation system may be additionally applied to a chassis system together with a vehicle body system.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing an overall configuration of an automatic evaluation system for vehicle devices according an exemplary embodiment of the present invention;

FIG. 2 is a front view showing a system base in an automatic evaluation system for vehicle devices according to an exemplary embodiment of the present invention;

FIG. 3 is a flow chart showing the automatic evaluation process for vehicle devices according to an exemplary embodiment of the present invention; and

FIG. 4 is a table of a test case data showing an output state of a room lamp in response to a door input according to an exemplary embodiment of the present invention.

Reference numerals set forth in the Drawings includes reference to the following elements as further discussed below:
1: test case data
100: vehicle simulator
110: controller
200: system base
210: control device
211: control program
212: test case converter
213: test case executer
214: port manager
220: signal input/output unit
230: diagnosis communication unit
240: power supplying unit
250: display
300: signal connecting unit

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, both gasoline-powered and electric-powered vehicles.

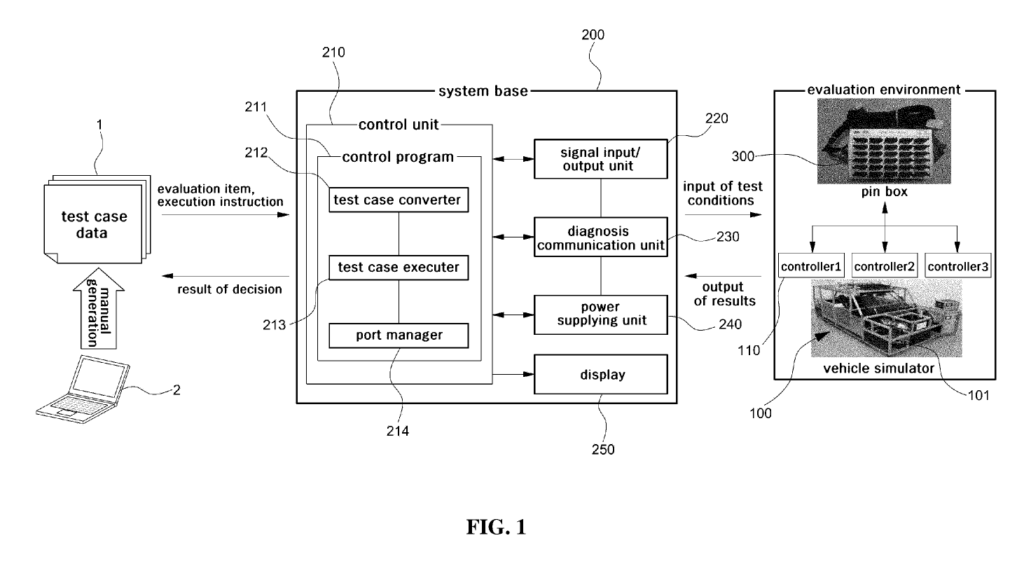

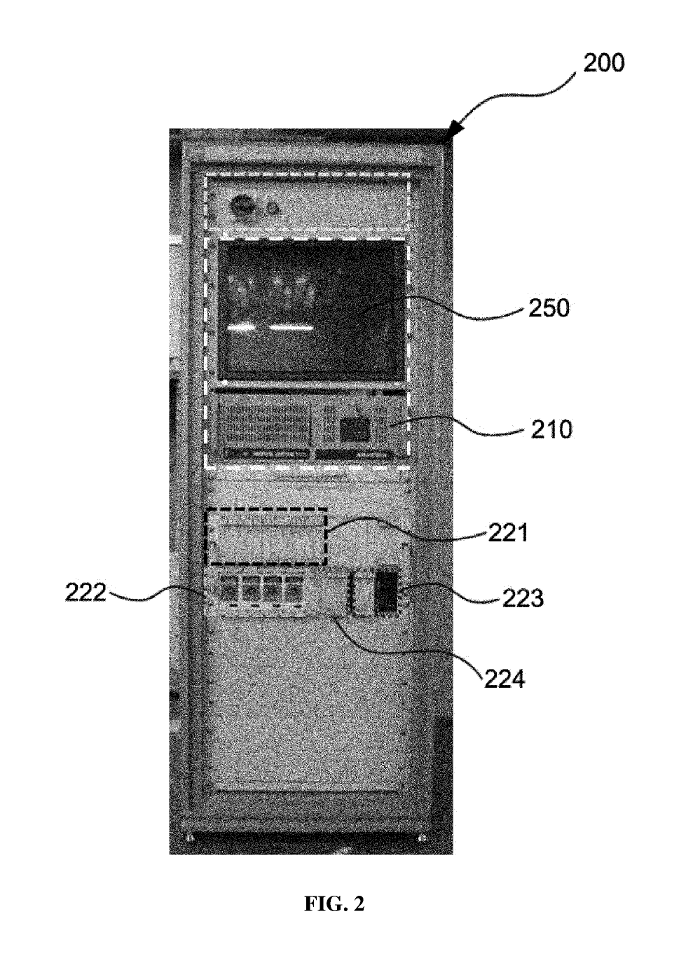

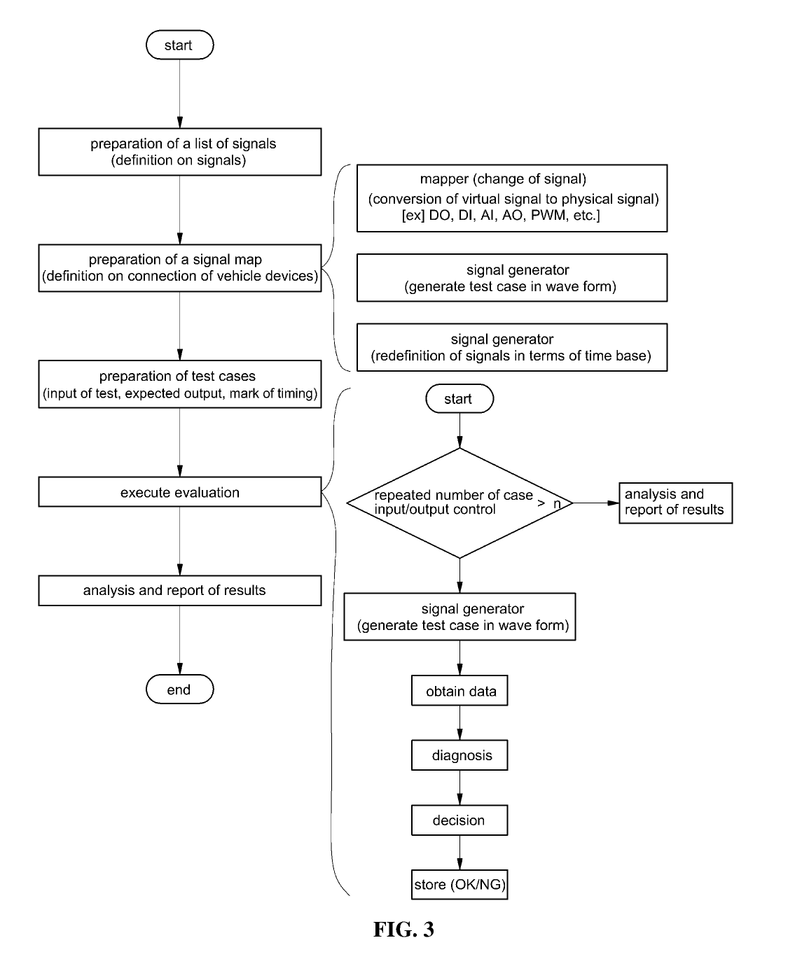

FIG. 1 is a schematic diagram showing the overall configuration of an automatic evaluation system for vehicle devices according an exemplary embodiment of the present invention. FIG. 2 is a front view showing a system base in an automatic evaluation system to for vehicle devices according to an exemplary embodiment of the present invention. Finally, FIG. 3 is a flow chart showing the automatic evaluation process for vehicle devices according to an exemplary embodiment of the present invention.

As shown in the drawings, the automatic evaluation system includes a vehicle simulator 100 that is configured to copy an actual vehicle in combination with vehicle devices mounted in a vehicle; a system base 200 that generates and outputs an input signal sent to a controller 110 to operate vehicle devices that are targeted for evaluation according to contents set in a test case data 1 entered by an evaluator. The system base 200 also measures and analyzes an output signal outputted from the controller 110 of a corresponding vehicle in response to the input signal. The automatic evaluation system further includes a signal connecting unit that connects the vehicle simulator 100 with the system base 200 via a signal, e.g., a wireless or wired signal.

The vehicle simulator 100 is configured in such a manner that various vehicle devices targeted for evaluation are mounted in each division of a frame 101 of the vehicle simulator 100 and operate in the same manner as they would in an actual vehicle in response to an input signal applied to the controller 110 from the system base 200. As would an actual vehicle mounted therein with each of the vehicle devices, the vehicle simulator 100 is configured to replicate an actual vehicle includes a controller 110 (for example, BCM), an input unit (e.g., door switch) for applying an input signal to the controller 110 to operate the vehicle device, an operation unit (e.g., room lamp) operating in response to an output signal (control signal) output from the controller 110, and wirings connected therebetween. In this manner, the vehicle simulator 100 is configured in combination with the vehicle devices similar to as they would be in an actual vehicle.

Such vehicle devices mounted in the vehicle simulator 100 may include a keyless entry system, a push button start system, an auto light system, a lamp system such as door switch room lamp and the like, a memory seat system, a wiper system (manual or automatic), a power window system, a rear side warning system, a voice warning system, a cluster, multifunction switch, a various kinds of vehicle devices associated with BCM (body control module), etc.

Such vehicle devices are listed just as exemplary devices which may be mounted in the vehicle simulator 100. The devices can be mounted in the vehicle simulator 100 of the present invention are not limited to the above-listed devices, but may be expanded to, for instance, an air conditioner, various kinds of devices associated with chassis control, etc.

The system base 200 serves as a signal generator to generate an input signal to be sent an input terminal (connected to the input unit) of the controller 110 of a corresponding vehicle device via the signal connecting unit 300, and receive an output signal from the controller 110 in response to the input signal. That is, the system base receives output signals sent from an output terminal of the controller 110 via the signal connecting unit 300 to thereby collect and analyze the resultant data.

The signal connecting unit 300 may be for example, any kind of connection unit which transmits a power input and a communication between the interfaces of the system base 200 and the vehicle simulator 100. The signal connecting unit 300 shown in the to drawing may be connected to a communication cable and a power cable that are connected to a power port and an input/output port of the system base 200 and may be a pin box provided with a plurality of connector terminals.

When the terminals of the communication cable and the power cable connected to the pin box are connected to the input/output port and the power port of the system base 200, and the terminal of the communication cable connected from the controller 110 of the vehicle simulator 100 side vehicle devices is connected via insertion to the selected connector terminal of the pin box, the system base 200 and the vehicle simulator 100 are electrically connected so that signal input/output and supply of power therebetween may be possible.

Herein, the system base 200 and the vehicle simulator 100 (for example, controller 110 of vehicle device) transmit various digital and analogue types of signals such as high/low signals, voltage signals, PWM signals, diagnosis signals and so on through the communication cable to provide communication therebetween. Additionally, the communication cables also make it possible to form a K-line (diagnosis) communication linkage and a CAN communication linkage between the system base 200 and the vehicle simulator 100.

Hereinafter, the system base in the automatic evaluation system will now be described in more detail.

The system base 200 for performing an automatic evaluation of a vehicle, serves to automatically apply an input signal to the controller 110 for each of the vehicle devices according to contents set in the test case data 1, and automatically perform an evaluation to to detect and analyze an output signal (e.g., a control signal applied to the operation unit) of the controller output from the controller 110 of the vehicle devices, at a complete vehicle level.

The system base 200 includes a control unit 210 for controlling an evaluation and analyzing the results in response to a content set according to a test case data prepared and inputted by an evaluator. The control unit is further configured to compare the analyzed data with an evaluation reference to perform an evaluation decision.

Also included the system base 200 is a signal input/output unit 220 for generating and outputting an input signal of the controller input to the controller 110 of the vehicle simulator 100 vehicle device in response to a control signal of the control unit 210. The signal input/output unit 220 also receives an output signal from the controller 110 of the vehicle device. This output signal contains the output of the controller 110. The signal input/output unit 220 then transmits the output signal to the control unit 210.

Furthermore, a power supplying unit 220 is also provided in system base 200 to supply electric power in order to operate the system base 200.

In some embodiments of the present invention, the system base 200 may further include a display 250 for displaying all information, such as evaluation setting information, evaluation procedure information, evaluation state information, result and analysis information, failure information and so on, that are transmitted from the control unit 210. That being said, the control unit 210, the display 250 and the input/output unit may be realized as a personal computer, a monitor, a keyboard, a mouse, etc.

In addition, the system base 200 may further include a diagnosis communication unit to 230 for monitoring, e.g., a controller area network (CAN) communication between each of the controller 110 of the vehicle simulator 100 and performing a diagnosis communication with the controller 110.

The control unit 210 is installed therein with a control program 211 that controls each of the operations of the system base 200 for carrying out an evaluation performance such as generating and outputting of an input signal of the controller based on contents set in the test case data 1, inputting and detecting of an output signal of the controller, performing a control function associated with an evaluation such as a power control function and the like, analyzing and deciding of the results, matching of pins for connecting the signal input/output unit 220 with the controller 110 of the vehicle devices, etc.

For example, the control program 211 installed in the control unit 210 may include a test case converter 212 for automatically converting the test case data 1 prepared and inputted by an evaluator to data available in another unit; a test case executer 213 for controlling of an evaluation performance, analyzing the results, and determining the evaluation; and a port manager 214 for connecting an input/output port of the signal input/output unit 220 with the controller 110 of the vehicle devices via e.g., pin-matching.

According to the present invention, the test case data 1 is created by testing and making a list of misuse and past cases such as user conditions. Additionally, the test case data corresponds to data in which diagnosis communications for each of the vehicle devices, actual operating conditions of the vehicle devices in a vehicle, evaluators' know-how for evaluation and so on are reflected. The test case data may include various data prescribing: evaluation items for specific vehicle devices, information and evaluation executing instructions based on an input signal from the controller relating to actual operating condition, a list and definition of all signals (e.g., a digital input control signal applied to the controller 110) generated during evaluation, definition of a signal connection between the vehicle devices (e.g., setting of pin-matching for connecting the vehicle devices), evaluation reference and output state (e.g., digital output) according to an input signal, setting of control of power supply, etc.

Such test case data 1 may be available in various formats such as an electronic data container that is stored in and input/output to the control unit 210 and read by the control program 211, e.g., excel file (EXCEL).

In this case, the control program 211 may be configured to set contents contained in the test case data 1 by the control unit 210 which is configured to read an electronic data container of the test case data 1 prepared in advance by an evaluator. In addition, the control program 211 may be configured to modify contents set according to the test case data 1 input or input an additional set content other than the contents of the test case data 1.

The test case data 1 may be manually generated by an evaluator using an external personal computer 2 and the like and input into an input/output unit of the control unit, for example, a USB port (which is used for transmission of data from the system base 200, loading of programs, and connection of an external computer 2), or the like.

After the evaluation, the test case data 1 may be additionally stored therein along with analysis information (e.g., voltage level and analysis of CAN communication data) and to detection results (e.g., data on wave forms and a voltage level output from the controller 110) according to each test case, information on evaluation results, data of CAN communication, log data etc. In addition, the test case data 1 stored therein with additional information may be transmitted to the external personal computer 2 to be used as a database.

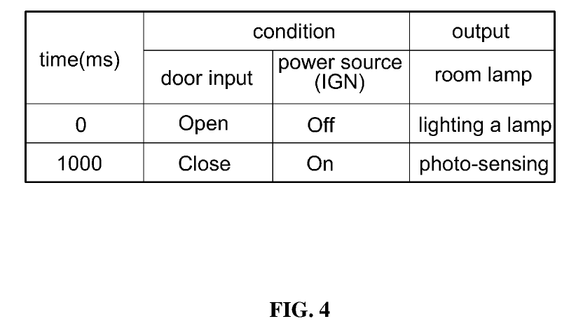

FIG. 4 is a table showing an example of the test case data prescribing an output state of a room lamp in response to an input of a door.

More specifically, the signal input/output unit 220 serves to generate and output an input signal (e.g., input signal to be applied to the controller 110 of the vehicle device) as defined in the test case data 1 when the test case executer 213 performs an evaluation and receive an output signal (for example, a signal associated with a voltage level) of the controller output from the controller 110 of the vehicle device to thereby transmit the output signal to the controller 210.

The power supplying unit 240 is configured to provide the electric power necessary for operation of the vehicle devices, and to control and supply electric power of a vehicle that is being replicated by to the vehicle simulator 100 according to the test case data 1. The power supplying unit 240 may be configured in combination with a power source control device (not shown) for controlling the electric power (B+/ACC/IG1/IG2) supplied to a vehicle using a power source, e.g., AC 220V, DC 12V (Battery) according to the test case data 1.

The display 250 may display for example test case numbers to be executed, an evaluation reference of the test case, and an input signal set according to the test case. An evaluator may select, execute and stop of the test cases, store the results and so on via the display 250 and keyboard/mouse, etc.

FIG. 2 shows the configuration of the system base 200 according to an exemplary embodiment of the present invention. In particular, the system base 200 is provided at a front side thereof with the control unit 210, display 250, digital signal input/output port 221 as a configuration element of the signal input/output unit 220, pulse width modulator (PWM) output port 222, analog input port 223 and output port 224.

Each of the signal input/output ports 221 to 224 corresponds to interfaces for connecting the signal input/output unit 220 to outside devices, the analog input port 223 is input via, e.g., an analog signal output from the controller 110, and the analog output port 224 is supplied with a vehicle electric power such as B+/ACC/IG1/IG2 and the like which is controlled by the power source control device connected to the power supplying unit 240. Also, in other embodiments of the present invention, various ports may be added to the system base in addition to the above-mentioned input/output ports.

Hereinafter, a process for evaluating the vehicle devices will now be described with reference to FIG. 3 according to the present invention.

FIG. 3 is a flow chart illustrating a procedure for preparing test case data and a process for evaluating the vehicle devices using the automatic evaluation system.

First, to prepare the test case data, an evaluator prepares a list of signals prescribing a definition for each signal and a signal map prescribing a definition of the connection between the vehicle devices. While preparing of the signal map, virtual signals are converted to to physical signals such as, for example, a digital output (DO), a digital input (DI), an analog output (AO), PWM, etc. The test cases are generated as wave forms, and then, redefined as signals based on time (e.g., at this time, use a Mapper in a map producing program, a signal generator, etc.). A ‘Mapper’ may have the functions of (a) redefining a list defined regarding the characteristics of signals (e.g., digital input, digital output, analogue input, analogue output, etc.) into a physical signal and (b) redefining a defined signal [e.g., test case (test condition approval list)] by means of a signal generator, thereby generating a wave form. In other words, by ‘Mapper’ it is meant a device which provides a practical/real signal so that, e.g., a test case, prepared in the form of a document, can be approved, in most cases automatically, in a vehicle simulator.

Next, the test case data 1 (e.g., the input of input, output of prediction, and mark of timing) is prepared using the signal map.

In this manner, after the test case data 1 has been prepared, cables connected to the vehicle simulator 100 (e.g., the input/output terminal of the controller and the input terminal of vehicle power supply) for executing an evaluation are connected to the pin box of the signal connecting unit 300, and the input/output ports of the system base 200 are connected to the pin box with the cables so as to be matched in, for example, a one to one ratio.

Next, when the test case data 1, prepared in advance, is input to the control unit 210 of the system base 200, and, then, the control program 211 is run in the control unit 210 to select the test case data 1, the test case converter 212, test case executer 213 and port manager 214 are executed, and at the same time, the control unit 210 automatically detects data thereby setting evaluation and controlling output of the vehicle simulator 100 to the vehicle devices. In other words, the control unit 210 outputs a control signal according to contents set in the test case data 1, and the signal input/output unit 220 generates and outputs an input signal of the controller 110 for controlling the operation of the vehicle devices mounted in the vehicle simulator 100 in response to the control signal. Accordingly, the controller 110 outputs a control signal in response to the input signal.

Next, the control unit 210 of the system base 200 receives a signal output from the controller 110 through the signal input/output unit 220, and the input and output of signal to the controller 110 is repeated a set number of times, and then, the control unit 210 of the system base 200 takes the resultant data and diagnoses and compares the resultant data with an expected value of the test case, (e.g., an evaluation reference). It is then determined by the control unit 210 whether the vehicle device passes or fails an evaluation based on the comparison result. The results are then stored for later use.

Advantageously, the automatic evaluation system provides an automatic evaluation mode for evaluating a device within a vehicle by using a vehicle simulator and test case data. The present invention also makes it possible to automate a time consuming repetitive process and a timing evaluation process, thereby reducing a work load, enhancing the reliability of evaluation, reducing the duration of evaluation, etc.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An automatic evaluation system for vehicle devices, comprising:
a vehicle simulator that is configured to replicate an actual vehicle in combination with vehicle devices mounted therein;
a system base that generates and outputs an input signal inputted to a controller to operate vehicle devices which are targeted for evaluation according to contents set in a test case data inputted by an evaluator and that detects and analyzes an output signal outputted from the controller in response to the input signal; and
a signal connecting unit that connects the vehicle simulator with the system base via a signal.

2. The automatic evaluation system for vehicle devices according to claim 1, wherein the vehicle simulator is configured to allow the vehicle devices mounted in each division of a frame to operate in the same manner as if each vehicle device was mounted in an actual vehicle in response to an input signal applied to the controller from the system base, the vehicle simulator configured in combination with the vehicle devices in a similar manner as the vehicle device would be mounted in the actual vehicle therein with a controller, an input unit for applying an input signal to the controller to operate the vehicle device, an operation unit operating in response to an output signal outputted from the controller, and wirings connected therebetween.

3. The automatic evaluation system for vehicle devices according to claim 1, wherein the system base comprises:
a control unit configured to control an evaluation and analyze the evaluation results in response to a content set according to test case data, and compare the analyzed data with an evaluation reference to perform an evaluation decision therein;
a signal input/output unit for generating and outputting an input signal for the controller input to the controller of the vehicle simulator vehicle device in response to a control signal from the control unit, and receiving an output signal output from the controller of the vehicle device to transmit the output signal to the control unit;
an input/output unit for input/output of data of the control unit;
a display for displaying information selected from the group consisting of evaluation setting information, evaluation procedure information, evaluation state information, result and analysis information, and decision result information that are transmitted from the control unit; and
a power supplying unit for supplying electric power to operate the system base.

4. The automatic evaluation system for vehicle devices according to claim 3, wherein the system base further comprises a diagnosis communication unit for monitoring a Control Area Network (CAN) communication with the vehicle simulator side controller and performing a diagnosis communication.

5. The automatic evaluation system for vehicle devices according to claim 3, wherein the control unit has a control program configured to control each system base operation for setting contents contained in the test case data by reading an electronic data container of test case data prepared in advance by an evaluator, and for performing an evaluation based on the contents set in the test case data.

6. The automatic evaluation system for vehicle devices according to claim 5, wherein the control program comprises:
a test case converter for automatically converting the test case data to available data;
a test case executer for controlling an evaluation performance, analyzing the results, and determining the evaluation result; and
a port manager for connecting an input/output port of the signal input/output unit with the controller of the vehicle devices.

7. The automatic evaluation system for vehicle devices according to claim 1, wherein the test case data is data prescribing: evaluation items for vehicle devices, evaluation executing instructions, a list and definition of all signals generated during evaluation, information on input signals of the controller relating to an actual operating condition, settings for connecting the vehicle devices, evaluation references and expected output states according to an input signal, and control setting for the power supply.

8. The automatic evaluation system for vehicle devices according to claim 3, wherein the power supplying unit is configured in combination with the power source control unit for controlling electric power of a vehicle using an AC 220V power source and a battery according to contents set in the test case data while supplying electric power necessary for operating the vehicle devices.

9. A method for automatically evaluating vehicle devices, the method comprising:
replicating an actual vehicle in combination with vehicle devices mounted therein via a vehicle simulator;
generating and outputting, by a system base, an input signal provided to a controller to operate vehicle devices which are targeted for evaluation according to one or more contents set in test case data entered by an evaluator
detecting and analyzing an output signal produced from the controller in response to the input signal;
diagnosing and comparing the resultant data with an expected value of the test case data; and
determining by the control unit whether the vehicle device passes or fails the evaluation based on the comparison result.

10. The method according to claim 9, further comprising:
controlling, by a first unit, an evaluation;
analyzing, by the first unit, the evaluation results based on a content set according to test case data;
comparing, by the first unit, the analyzed data with an evaluation reference to perform an evaluation decision therein;
generating and outputting an input signal, by a second unit, to the controller of vehicle device mounted on the vehicle simulator in response to a control signal from the first unit; and
receiving an output signal from the controller of the vehicle device to transmit the output signal to the first unit.

11. The method of claim 9, the method further comprising
displaying information, on a display, the information selected from a group consisting of evaluation setting information, evaluation procedure information, evaluation state information, result and analysis information, and decision result information that are transmitted from the control unit.

12. An automatic evaluation system for vehicle devices, comprising:
a vehicle simulator configured to replicate a vehicle in combination with vehicle devices mounted therein;
a system base configured to generate and output an input signal to be input into a controller in order to operate one or more vehicle devices which are targeted for evaluation according to contents set in test case data entered by an evaluator, the system base further configured to automatically detect and analyze an output signal received from the controller; and
a first unit configured to connect the vehicle simulator with the system base via a signal.
